(19) United States
(12) Patent Application Publication
(10) Pub. No.: US 2025/0308536 A1
(43) Pub. Date: Oct. 2, 2025

(54) APPARATUS AND METHOD FOR RECOGNIZING CONVERSATIONAL CONTEXT IN ROBOT

(71) Applicant: ELECTRONICS AND TELECOMMUNICATIONS RESEARCH INSTITUTE, Daejeon (KR)

(72) Inventors: Jae-Yoon JANG, Daejeon (KR); Woo-Ri KO, Daejeon (KR); Jae-Hong KIM, Daejeon (KR); Young-Woo YOON, Daejeon (KR)

(21) Appl. No.: 19/059,827

(22) Filed: Feb. 21, 2025

(30) Foreign Application Priority Data
Mar. 29, 2024 (KR) 10-2024-0043346

(51) Int. Cl. G10L 17/10; G06V 20/40; G06V 40/18; G10L 17/22; G10L 25/57

(52) U.S. Cl. CPC G10L 17/10; G06V 20/41; G06V 20/46; G06V 40/193; G10L 17/22; G10L 25/57

(57) ABSTRACT

Disclosed herein are an apparatus and method for recognizing a conversational context in a robot. The apparatus for recognizing a conversational context in a robot includes memory configured to store at least one program, and a processor configured to execute the program, wherein the program is configured to perform recognizing a speaker and an intended recipient from a robot's Point-of-View (POV) video, and classifying a social interaction state of the robot as one of predefined social interaction states depending on the recognized speaker and the recognized intended recipient.

### CROSS REFERENCE TO RELATED APPLICATION

This application claims the benefit of Korean Patent Application No. 10-2024-0043346, filed Mar. 29, 2024, which is hereby incorporated by reference in its entirety into this application.

### BACKGROUND OF THE INVENTION

### 1. Technical Field

The following embodiments relate to technology for generating the reaction of a robot in a Human Robot Interaction (HRI) context.

### 2. Description of Related Art

Recently, due to the rapid development of Artificial Intelligence (AI) technology, interactions between humans and robots are increasing, and interactions that are made based on responses generated by robots are gradually increasing. In spite of this development, people still feel that interactions with robots are unnatural in many cases. Although there are many factors causing people to feel that interactions are unnatural, the reason highlighted in the present disclosure is “robot interventions that are inappropriate for the current context”.

However, generating the response of each robot in the Human Robot Interaction (HRI) context may be one of the largest factors allowing users to feel natural.

However, in generating the response of the robot, the robot may respond at appropriate or inappropriate timing depending on the conversational context. For example, the inappropriate timing may be a situation where two people are conversing near the robot and the robot intervenes without being called.

Since robots in daily life areas are still at the level of auxiliary tools, people inevitably consider a situation in which the corresponding robot actively intervenes to be unnatural. Moreover, in the case where the situation does not involve calling the robot or showing interest in the robot, people find such an intervention even more unnatural.

Due to the above-described reasons, a problem arises in that each robot needs to identify social interaction context information in order to enhance natural interaction performance of the robot.

### SUMMARY OF THE INVENTION

An embodiment is intended to enhance interaction performance so that a robot generates a natural response in conformity with a current situation in a Human Robot Interaction (HRI) context.

In accordance with an aspect, there is provided an apparatus for recognizing a conversational context in a robot, including memory configured to store at least one program, and a processor configured to execute the program, wherein the program is configured to perform recognizing a speaker and an intended recipient from a robot's Point-of-View (POV) video, and classifying a social interaction state of the robot as one of predefined social interaction states depending on the recognized speaker and the recognized intended recipient.

The program may be configured to, in the recognizing, recognize the speaker and the intended recipient based on multimodal recognition of audio and video from the robot's POV video.

The program may be configured to perform, in the recognizing, encoding an audio feature extracted from the robot's POV video, encoding a face region in a frame extracted from the robot's POV video, encoding the frame extracted from the robot's POV video, generating a combined feature vector from information obtained by encoding at least one of the audio feature, the face region or the frame, or a combination thereof, and recognizing the speaker and the intended recipient from the combined feature vector.

The program may be configured to further perform, in the recognizing, recognizing and encoding a gaze point from the frame extracted from the robot's POV video, generating a gaze point feature vector based on encoded information and the combined feature vector, decoding the gaze point feature vector, and recognizing the gaze point based on decoded information.

The program may be configured to recognize the speaker and the intended recipient based on the combined feature vector and decoded information of the gaze point feature vector in the recognizing.

The predefined social interaction states may include at least one of a first state in which the speaker is a main user and the intended recipient is the robot, a second state in which the speaker is the main user and the intended recipient is a surrounding user, or a third state in which the speaker is the surrounding user and the intended recipient is unclear, or a combination thereof.

The program may be configured to further perform generating a response of the robot corresponding to a result classified as one of the predefined social interaction states.

The program may be configured to, when the social interaction state is the first state, generate the response of the robot as an interaction with the main user.

The program may be configured to, when the social interaction state is the second state, generate the response of the robot as waiting or intervention based on a result of determining context information.

The program may be configured to, when the social interaction state is the third state, generate the response of the robot as waiting.

In accordance with another aspect, there is provided a method for recognizing a conversational context in a robot, including recognizing a speaker and an intended recipient based on multimodal recognition of audio and video from a robot's Point-of-View (POV) video, and classifying a social interaction state of the robot as one of predefined social interaction states depending on the recognized speaker and the recognized intended recipient.

The recognizing may include encoding an audio feature extracted from the robot's POV video, encoding a face region in a frame extracted from the robot's POV video, encoding the frame extracted from the robot's POV video, generating a combined feature vector from information obtained by encoding at least one of the audio feature, the face region or the frame, or a combination thereof, and recognizing the speaker and the intended recipient from the combined feature vector.

The recognizing may include recognizing a gaze point from the extracted from the robot's POV video and encoding the gaze point, generating a gaze point feature vector based on encoded information and the combined feature vector, decoding the gaze point feature vector, and recognizing the gaze point based on decoded information.

The recognizing may further include recognizing the speaker and the intended recipient based on the combined feature vector and decoded information of the gaze point feature vector.

The predefined social interaction states may include at least one of a first state in which the speaker is a main user and the intended recipient is the robot, a second state in which the speaker is the main user and the intended recipient is a surrounding user, or a third state in which the speaker is the surrounding user and the intended recipient is unclear, or a combination thereof.

The method may further include generating a response of the robot corresponding to a result classified as one of the predefined social interaction states.

Generating the response may include, when the social interaction state is the first state, generating the response of the robot as an interaction with the main user.

Generating the response may include, when the social interaction state is the second state, generating the response of the robot as waiting or intervention based on a result of determining context information.

Generating the response may include, when the social interaction state is the third state, generating the response of the robot as waiting.

In accordance with a further aspect, there is provided a method for recognizing a conversational context in a robot, including recognizing a speaker and an intended recipient based on multimodal recognition of audio and video from a robot's Point-of-View (POV) video, classifying a social interaction state of the robot as one of predefined social interaction states depending on the recognized speaker and the recognized intended recipient, and generating a response of the robot corresponding to a result classified as one of the predefined social interaction states, wherein, when the social interaction state is the first state in which in the speaker is a main user and the intended recipient is the robot, the response of the robot is generated as an interaction with the main user, wherein, when the social interaction state is the second state in which the speaker is the main user and the intended recipient is a surrounding user, the response of the robot is generated as waiting or intervention based on a result of determining context information, and wherein, when the social interaction state is the third state in which the speaker is the surrounding user and the intended recipient is unclear, the response of the robot is generated as waiting.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a flowchart illustrating a method for recognizing a conversational context in a robot according to an embodiment;

FIGS. 2 to 4 are diagrams illustrating examples of predefined social interaction states according to an embodiment;

FIG. 5 is a flowchart for explaining the step of recognizing a speaker and an intended recipient according to an embodiment; and

FIG. 6 is a diagram illustrating the configuration of a computer system according to an embodiment.

### DESCRIPTION OF THE PREFERRED EMBODIMENTS

Advantages and features of the present disclosure and methods for achieving the same will be clarified with reference to embodiments described later in detail together with the accompanying drawings. However, the present disclosure is capable of being implemented in various forms, and is not limited to the embodiments described later, and these embodiments are provided so that this disclosure will be thorough and complete and will fully convey the scope of the present disclosure to those skilled in the art. The present disclosure should be defined by the scope of the accompanying claims. The same reference numerals are used to designate the same components throughout the specification.

It will be understood that, although the terms “first” and “second” may be used herein to describe various components, these components are not limited by these terms. These terms are only used to distinguish one component from another component. Therefore, it will be apparent that a first component, which will be described below, may alternatively be a second component without departing from the technical spirit of the present disclosure.

The terms used in the present specification are merely used to describe embodiments, and are not intended to limit the present disclosure. In the present specification, a singular expression includes the plural sense unless a description to the contrary is specifically made in context. It should be understood that the term “comprises” or “comprising” used in the specification implies that a described component or step is not intended to exclude the possibility that one or more other components or steps will be present or added.

Unless differently defined, all terms used in the present specification can be construed as having the same meanings as terms generally understood by those skilled in the art to which the present disclosure pertains. Further, terms defined in generally used dictionaries are not to be interpreted as having ideal or excessively formal meanings unless they are definitely defined in the present specification.

The present disclosure is intended to allow a robot to recognize a social conversational state of a user and then enhance natural interaction performance in HRI context, and proposes technology for analyzing a social conversional state based on information obtained by recognizing a speaker and an intended recipient (also referred to as an intended listener or an addressed recipient) and utilizing the result of analysis as a cue for generating a response suitable for the corresponding context.

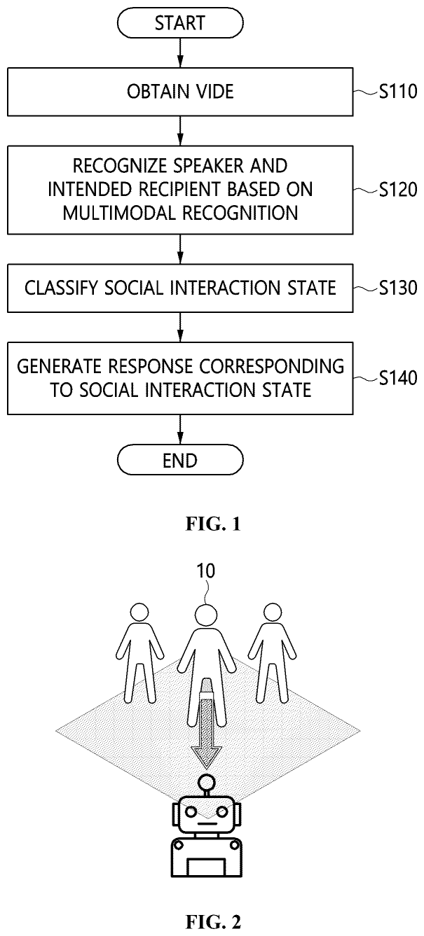

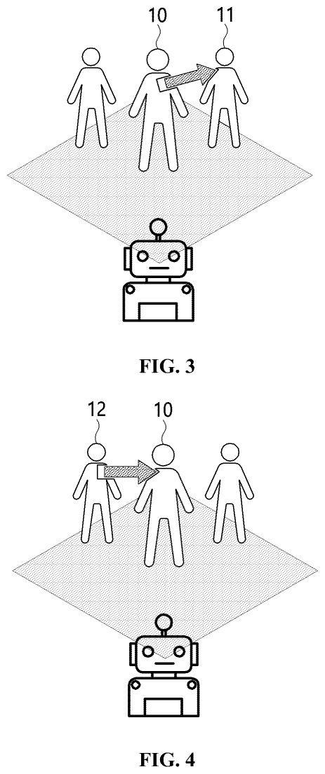

FIG. 1 is a flowchart illustrating a method for recognizing a conversational context in a robot according to an embodiment, and FIGS. 2 to 4 are diagrams illustrating examples of predefined social interaction states according to an embodiment.

Referring to FIG. 1, the method for recognizing a conversational context in a robot according to an embodiment may include steps S110 and S120 of recognizing a speaker and an intended recipient based on multimodal recognition of audio and video (image) from a robot's Point-of-View (POV) video, and step S130 of classifying the social interaction state of the robot as one of predefined social interaction states depending on the recognized speaker and the recognized intended recipient.

The method for recognizing a conversational context in a robot according to the embodiment may further include step S140 of generating the response of the robot corresponding to the result classified as one of the predefined social interaction states.

That is, as shown in FIGS. 2 to 4, in a situation in which N persons are present within the view of the robot and are capable of speaking, the speaker and the intended recipient are recognized, conversational contexts therebetween are identified, and interaction levels suitable for respective contexts are limited, thus suppressing the generation of responses that may cause the persons to feel unnatural and activating the generation of interaction responses that allow the persons to feel more natural.

In this case, the predefined social interaction states according to an embodiment may include at least one of a first state in which the speaker is a main user 10 and the intended recipient is a robot, as shown in FIG. 2, a second state in which the speaker is the main user 10 and the intended recipient is a surrounding user 11, as shown in FIG. 3, or a third state in which the speaker is a surrounding user 12 and the intended recipient is unclear, or a combination thereof.

In an embodiment, the speaker refers to the person who is speaking, and the intended recipient refers to the person to whom the speaker intends to speak, rather than everyone listening. The main user is the person who is interacting with the robot or a user recognized by the robot as an interaction target at the closest position, and the surrounding user refers to any of the remaining users who are within the robot's Field of View (FOV), aside from the main user, or users whose audio (speech) signals are generated in a surrounding area and are detectable by the robot.

Here, the step of generating the response may include the step of generating the response of the robot as an interaction with the main user when the social interaction state is the first state. That is, when the main user 10 speaks and the target is the robot, the robot may normally interact with the main user 10.

Here, the step of generating the response may include the step of, when the social interaction state is the second state, generating the response of the robot as ‘waiting’ or ‘intervention’ based on the result of identifying context information. That is, when the main user 10 speaks and the intended recipient is the surrounding user 11, the robot may determine the context information of the recognized conversation and then wait or suitably intervene in the conversation.

Here, the step of generating the response may include the step of generating the response of the robot as waiting when the social interaction state is the third state. That is, when the surrounding user 11 speaks and the intended recipient is not designated, the current situation is not a state in which the robot generates a response, and thus the robot needs to be able to wait without generating a response.

Here, in a situation in which the surrounding user speaks, even a user who is out of the robot's field of view and from whom only speech is input to the robot, as well as the surrounding user who is within the robot's field of view, may also be included in the range of the speaker.

Meanwhile, when the number of persons who interact with the robot is one, other than N, the social interaction state may be determined to be the first state in which the main user 10 speaks and the intended recipient is the robot.

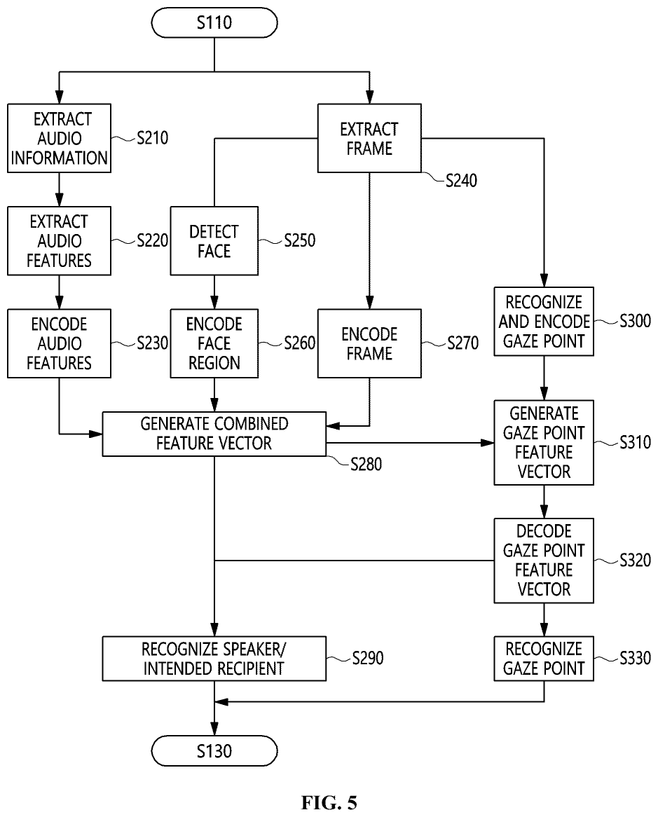

FIG. 5 is a flowchart for explaining the step of recognizing a speaker and an intended recipient according to an embodiment.

Referring to FIG. 5, the step of recognizing a speaker and an intended recipient may include steps S210 to S230 of encoding audio features extracted from a robot's Point-of-View (POV) video, steps S240 to S260 of encoding a face region in a frame extracted from the robot's POV video, steps S240 and S270 of encoding the frame extracted from the robot's POV video, step S280 of generating a combined feature vector from information obtained by encoding at least one of the audio features, the face region or the frame, or a combination thereof, and step S290 of recognizing the speaker and the intended recipient from the combined feature vector.

That is, in an embodiment, in order to recognize the speaker and the intended recipient, video information (image information) and audio information of the robot's POV video are used together.

Here, as the video information, the entire video information in each frame extracted from the robot's POV video at step S240 and information of the face region detected from the frame at step S250 are used. As the audio information, audio information extracted at step S210 may be converted into and used with the audio features at step S220.

Here, in order to perform face detection at step S250 and audio feature extraction at step S220, an algorithm including RetinaFace, Mel-Frequency Cepstral Coefficients (MFCC), or the like may be used. However, this is only an example, and the extraction algorithm used in the present disclosure is not limited thereto.

Also, in order to merge respective regions and the feature information into the same domain, one or more of the encoded audio features, encoded face region features, and encoded frame features that are generated through the encoding processes S230, S260, and S270 may be combined with each other to generate one feature vector at step S280.

Here, the recognizing step according to the embodiment may further include steps S240 and S300 of recognizing and encoding a gaze point from the frame extracted from the robot's POV video, step S310 of generating a gaze point feature vector from the encoded information and the combined feature vector, step S320 of decoding the gaze point feature vector, and step S330 of recognizing the gaze point based on decoded information.

That is, separately from steps S210 to S280, the gaze point may be recognized from the frame information through an encoder-decoder structure network.

Here, the combined feature vector generated at step S280 may be utilized together as auxiliary information for gaze point recognition.

Furthermore, at the recognizing step S290, the speaker and the intended recipient may be recognized based on information, generated by decoding the generated gaze point feature vector at step S320, in addition to the combined feature vector generated at step S280.

That is, the step of recognizing the speaker and the intended recipient may be performed based on a pre-trained artificial neural network.

Here, the artificial neural network may be pre-trained to encode at least one of the audio features, the face region, and the frame, which are extracted from the video, and to infer the speaker from the combined feature vector into which at least one of the encoded the audio features, the face region, and the frame are combined.

Further, the artificial neural network may be pre-trained to infer the intended recipient based on the combined feature vector and the result of recognition of the gaze point extracted from the video frame.

The artificial neural network according to the embodiment may use, as training data, various types of video data including various conversational context cases of multiple participants, and may be trained to infer the speaker and the intended recipient that are the correct answers, based on the results of extracting the audio features, the face region, the frame, the gaze point, etc. from the video data. It is noted that the above-described method for recognizing a conversational context in a robot according to the embodiment may be extended and applied to all AI systems that are capable of receiving video and audio inputs, other than a robotic environment.

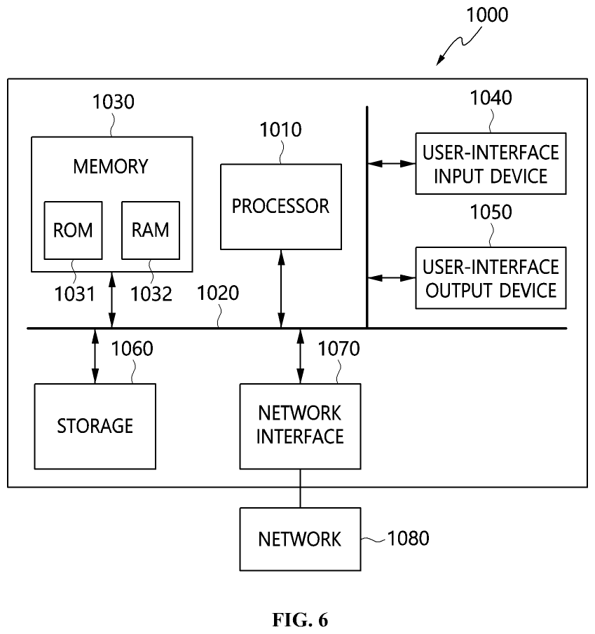

FIG. 6 is a diagram illustrating the configuration of a computer system according to an embodiment.

An apparatus for recognizing a conversational context in a robot according to an embodiment may be implemented in a computer system 1000 such as a computer-readable storage medium.

The computer system 1000 may include one or more processors 1010, memory 1030, a user interface input device 1040, a user interface output device 1050, and storage 1060, which communicate with each other through a bus 1020. The computer system 1000 may further include a network interface 1070 connected to a network 1080. Each processor 1010 may be a Central Processing Unit (CPU) or a semiconductor device for executing programs or processing instructions stored in the memory 1030 or the storage 1060. Each of the memory 1030 and the storage 1060 may be a storage medium including at least one of a volatile medium, a nonvolatile medium, a removable medium, a non-removable medium, a communication medium or an information delivery medium, or a combination thereof. For example, the memory 1030 may include Read-Only Memory (ROM) 1031 or Random Access Memory (RAM) 1032.

The above-described apparatus for recognizing a conversational context in a robot may perform the method for recognizing a conversational context in a robot, described above with reference to FIGS. 1 to 5, on the computer system illustrated in FIG. 6.

In accordance with embodiments, interaction performance may be improved so that a robot generates a natural response in conformity with a current situation in a Human Robot Interaction (HRI) context.

In accordance with embodiments, a robot generates a suitable response corresponding to the result of recognizing a current state and utilizes the generated response as a cue for determining the course of action, thus solving a problem related to generation of an unnatural interaction response that occurred in conventional technology.

Although the embodiment of the present disclosure has been disclosed, those skilled in the art will appreciate that the present disclosure can be implemented as other concrete forms, without departing from the scope and spirit of the disclosure as disclosed in the accompanying claims. Therefore, it should be understood that the exemplary embodiment is only for illustrative purpose and do not limit the scope of the present disclosure.

What is claimed is:

1. An apparatus for recognizing a conversational context in a robot, comprising:
a memory configured to store at least one program; and
a processor configured to execute the program,
wherein the program is configured to perform:
recognizing a speaker and an intended recipient from a robot's Point-of-View (POV) video; and
classifying a social interaction state of the robot as one of predefined social interaction states depending on the recognized speaker and the recognized intended recipient.

2. The apparatus of claim 1, wherein the program is configured to, in the recognizing, recognize the speaker and the intended recipient based on multimodal recognition of audio and video from the robot's POV video.

3. The apparatus of claim 2, wherein the program is configured to perform, in the recognizing,
encoding an audio feature extracted from the robot's POV video;
encoding a face region in a frame extracted from the robot's POV video;
encoding the frame extracted from the robot's POV video;
generating a combined feature vector from information obtained by encoding at least one of the audio feature, the face region or the frame, or a combination thereof; and
recognizing the speaker and the intended recipient from the combined feature vector.

4. The apparatus of claim 3, wherein the program is configured to further perform, in the recognizing,
recognizing and encoding a gaze point from the frame extracted from the robot's POV video;
generating a gaze point feature vector based on encoded information and the combined feature vector;
decoding the gaze point feature vector; and
recognizing the gaze point based on decoded information.

5. The apparatus of claim 4, wherein the program is configured to recognize the speaker and the intended recipient based on the combined feature vector and decoded information of the gaze point feature vector in the recognizing.

6. The apparatus of claim 1, wherein the predefined social interaction states include at least one of a first state in which the speaker is a main user and the intended recipient is the robot, a second state in which the speaker is the main user and the intended recipient is a surrounding user, or a third state in which the speaker is the surrounding user and the intended recipient is unclear, or a combination thereof.

7. The apparatus of claim 6, wherein the program is configured to further perform:
generating a response of the robot corresponding to a result classified as one of the predefined social interaction states.

8. The apparatus of claim 7, wherein the program is configured to, when the social interaction state is the first state, generate the response of the robot as an interaction with the main user.

9. The apparatus of claim 7, wherein the program is configured to, when the social interaction state is the second state, generate the response of the robot as waiting or intervention based on a result of determining context information.

10. The apparatus of claim 7, wherein the program is configured to, when the social interaction state is the third state, generate the response of the robot as waiting.

11. A method for recognizing a conversational context in a robot, comprising:
recognizing a speaker and an intended recipient based on multimodal recognition of audio and video from a robot's Point-of-View (POV) video; and
classifying a social interaction state of the robot as one of predefined social interaction states depending on the recognized speaker and the recognized intended recipient.

12. The method of claim 11, wherein the recognizing comprises:
encoding an audio feature extracted from the robot's POV video;
encoding a face region in a frame extracted from the robot's POV video;
encoding the frame extracted from the robot's POV video;
generating a combined feature vector from information obtained by encoding at least one of the audio feature, the face region or the frame, or a combination thereof; and
recognizing the speaker and the intended recipient from the combined feature vector.

13. The method of claim 11, wherein the recognizing comprises:
recognizing a gaze point from the extracted from the robot's POV video and encoding the gaze point;
generating a gaze point feature vector based on encoded information and the combined feature vector;
decoding the gaze point feature vector; and
recognizing the gaze point based on decoded information.

14. The method of claim 13, wherein the recognizing further comprises:
recognizing the speaker and the intended recipient based on the combined feature vector and decoded information of the gaze point feature vector.

15. The method of claim 11, wherein the predefined social interaction states include at least one of a first state in which the speaker is a main user and the intended recipient is the robot, a second state in which the speaker is the main user and the intended recipient is a surrounding user, or a third state in which the speaker is the surrounding user and the intended recipient is unclear, or a combination thereof.

16. The method of claim 15, further comprising:
generating a response of the robot corresponding to a result classified as one of the predefined social interaction states.

17. The method of claim 16, wherein generating the response comprises:
when the social interaction state is the first state, generating the response of the robot as an interaction with the main user.

18. The method of claim 16, wherein generating the response comprises:
when the social interaction state is the second state, generating the response of the robot as waiting or intervention based on a result of determining context information.

19. The method of claim 16, wherein generating the response comprises:
when the social interaction state is the third state, generating the response of the robot as waiting.

20. A method for recognizing a conversational context in a robot, comprising:
recognizing a speaker and an intended recipient based on multimodal recognition of audio and video from a robot's Point-of-View (POV) video;
classifying a social interaction state of the robot as one of predefined social interaction states depending on the recognized speaker and the recognized intended recipient; and
generating a response of the robot corresponding to a result classified as one of the predefined social interaction states,
wherein, when the social interaction state is a first state in which in the speaker is a main user and the intended recipient is the robot, the response of the robot is generated as an interaction with the main user,
wherein, when the social interaction state is a second state in which the speaker is the main user and the intended recipient is a surrounding user, the response of the robot is generated as waiting or intervention based on a result of determining context information, and
wherein, when the social interaction state is a third state in which the speaker is the surrounding user and the intended recipient is unclear, the response of the robot is generated as waiting.
